(19) United States
(12) Patent Application Publication
(10) Pub. No.: US 2007/0231254 A1
(43) Pub. Date: Oct. 4, 2007

(54) DIRECT SYNTHESIS AND METHODS OF USING HYDROGEN STORAGE MATERIALS

(76) Inventor: Karl Gross, Fremont, CA (US)

Correspondence Address: STEVEN VOSEN, 1563 SOLANO AVENUE #206, BERKELEY, CA, 94707, US

(21) Appl. No.: 11/693,874

(22) Filed: Mar. 30, 2007

Related U.S. Application Data
(60) Provisional application No. 60/744,113, filed on Mar. 31, 2006.
(60) Provisional application No. 60/744,934, filed on Apr. 16, 2006.

(51) Int. Cl. C01B 3/00

(52) U.S. Cl. 423/658.2

(57) ABSTRACT

A method is described for the direct synthesis of reversible hydride materials by hydrogenating a mixture of aluminum, an alkali-metal hydride, and one or more of an alkali-metal amide or an alkali-metal imide, an alkaline-earth-metal or alkaline-earth-metal hydride, and a transition metal catalyst. In one embodiment, the mixture includes aluminum, LiH, LiNH₂, magnesium, and TiF₃ in the molar ratio of 1:1:2:1:0.05. The material is capable of being repeatedly hydrogenated and dehydrogenated. The method is likely capable of forming a variety of hydrogen storage materials that includes alanates and amides or imides, and which have high hydrogen storage capabilities without the use of ammonia. A method is also described of using two component hydrogen storage materials by segregating the material components.

### CROSS-REFERENCE TO RELATED APPLICATIONS

This application claims the benefit of U.S. Provisional Application No. 60/744,113, filed Mar. 31, 2006, and U.S. Provisional Application No. 60/744,934, filed Apr. 16, 2006. The entire contents of the above-listed provisional applications are hereby incorporated by reference herein and made part of this specification.

### BACKGROUND OF THE INVENTION

1. Field of the Invention

This invention relates to a method of producing materials for reversibly storing hydrogen and methods of using hydrogen storage materials.

2. Description of the Prior Art

There is widespread interest in developing systems for storing hydrogen, in particular for use as fuel storage components for fuel cell systems. It is generally accepted that useful hydrogen storage systems should have high hydrogen storage densities and should preferably be reusable (that is, can be recharged with hydrogen when empty). Other requirements include safety, minimal energy or hydrogen losses, system lifetime, and compatibility with whatever devices are utilizing the hydrogen. Proposed systems include containers capable of storing hydrogen gas at high-pressure, cryogenic systems for storing liquid hydrogen, and systems that include materials that release hydrogen gas upon reaction of gaseous and/or liquid compounds, or that include solid compounds that can reversibly react with hydrogen, such as hydrides.

One type of hydrogen storage material includes alkali-metal-aluminum-amides. These compounds are known to release copious amounts of hydrogen through catalytically enhanced decomposition. Such processes are irreversible because hydrogen and ammonia generation is taken through a complete series of decomposition reactions that result in very stable metal-nitrides as the end product. This material has the disadvantage of not being reversible.

Another type of hydrogen storage material includes compounds based on the hydrides of alkali metals and aluminum, and which belong to belong to the larger class of complex hydrides. These compounds are also known to liberate copious amounts of hydrogen, either by direct thermal decomposition or by one-time hydrolysis. It is known, for example, that alkali-metal amides are formed through solid-gas-phase chemical reactions involving a complete chemical composition change on going from the precursor to the hydrided compounds In like manner, hydrogen stored in these amides is released through chemical decomposition reactions (see, for example, P. Chen, Z. Xiong, J. Luo, J. Lin, K. L. Tan, Nature, 420 (2002), W. Luo, Journal of Alloys and Compounds, 381 (2004), 284.). It is also known that hydrogen is absorbed and desorbed in reversible reactions in the better known Na—Al—H system (see, for example, C. M. Jensen and K. J. Gross, Appl. Phys. A 72, 213-219 (2001)). LiH is a decomposition product of the Li₃AlH₆ and LiAlH₄ hydrogen release reactions and LiH is a necessary component for the release of hydrogen from Li-amides.

Particularly promising systems for reversibly storing hydrogen at high density are complex hydrides, such as sodium aluminum hydride (NaAlH₄), which is also known as sodium alanate. Alanates are compounds having one or more AlH₄ or AlH₆ groups, e.g. LiAlH₄ or Mg(AlH₄)₂. Other systems are based on the reaction of lithium aluminum tetrahydride (LiAlH₄) and ammonia (NH₃) to release gaseous hydrogen. The chemistry of these systems is complex, rapid and difficult to control.

As an illustrative example of such a hydride-amide-imide system, for example, LiAlH₄ reacts with ammonia according to release hydrogen (see Schmidt, J., Lucero, R., Lynch, F., Wilkes, J. S., and Vaughn, L. R., “Ammonia-Hydride Hydrogen Generator for Portable Fuel Cell Power Systems,” Presentation 100th Electrochemical Society Meeting Philadelphia 12-17 May 2002.), where

LiAlH₄+4NH₃ [symbol] LiAl(NH₂)₄+4H₂ 7.5 wt. % H₂, Reaction (1)

and lithium aluminum amide LiAl(NH₂)₄ decomposes as follows:

LiAl(NH₂)₄ [symbol] LiAl(NH)₂+2NH₃ (100° C.) Reaction (2)

into lithium aluminum imide and ammonia.

Another promising system is based on the reaction of lithium aluminum hexahydride (Li₃AlH₆) and ammonia to release hydrogen gas as follows:

Li₃AlH₆+6NH₃→2LiNH₂+LiAl(NH₂)₄+6H₂ 7.7 wt. % H₂ Reaction (3)

LiAl(NH₂)₄→LiAl(NH)₂+2NH₃ (100° C.) Reaction (4)

### While the Li₃AlH₆ system may be more controllable than the LiAlH₄ system, they both require the use of gaseous ammonia, making it unlikely that they will be acceptable for use by the general public.

Another problem with hydrogen storage materials is that they can be difficult to produce. While simple alkali earth hydrides may be produced by direct reaction between molten alkali metal and hydrogen (at very high pressures and temperatures) preparation of the more complex hydrides of these metals has typically required development of specialized, individual processes. Thus, for example, a direct synthesis method to produce hydrides of aluminum with lithium, sodium, and potassium has been demonstrated by placing either the alkali metal or its hydride into an autoclave with activated aluminum powder in a solvent such as tetrahydrofuran. The mixture is subjected to hydrogen at a pressure of 2000 psi (about 135 atm) and heated to 150° C. for several hours after which the mixture is cooled, the excess aluminum is separated by filtration, and the NaAlH₄ isolated by precipitation using a hydrocarbon additive such as toluene to the tetrahydrofuran solution, followed by vacuum distillation of the tetrahydrofuran. The method is applicable to the production of LiAlH₄, NaAlH₄, KAlH₄ and CsAlH₄.

Recently, it has been shown that catalyzed hydride compounds, such as NaAlH₄ and Na₃AlH₆, can be synthesized using a more direct approach by hydriding ball-milled mixtures of NaH or Na, aluminum metal powder, and the catalyst precursor TiCl₃ or TiF₃.

There is a need for methods of producing reversible hydrogen storage materials from complex hydrides that are light-weight, reusable, and that have operating characteristics useful in hydrogen systems.

### BRIEF SUMMARY OF THE INVENTION

The present invention overcomes the disadvantages of prior art by providing a method of producing a material that reversibly stores hydrogen through one or more solid-state decomposition and formation reactions. In certain embodiments, the material is a hydrogenated mixture of two or more materials.

In certain embodiments, a method is provided for producing hydrogen storage materials capable of reversible hydrogenation. The method includes forming a mixture including an alkali-metal hydride, one or more of an alkali-metal amide or an alkali-metal imide, and a material selected from the group consisting of aluminum, one or more of an alkaline-earth-metal or an alkaline-earth-metal hydride, and any combination thereof, and hydrogenating the mixture at an elevated temperature and pressure.

In certain embodiments, a method is provided for producing hydrogen storage materials capable of reversible hydrogenation. The method includes forming a mixture including aluminum, an alkali-metal hydride, and one or more of an alkali-metal amide or an alkali-metal imide, and hydrogenating the mixture at an elevated temperature and pressure. In one embodiment, mixture includes one or more of an alkaline-earth-metal or an alkaline-earth-metal hydride which may include, for example and without limitation, magnesium.

In other certain embodiments, a method is provided for producing hydrogen storage materials capable of reversible hydrogenation. The method includes forming a mixture including an alkali-metal hydride, one or more of an alkali-metal amide or an alkali-metal imide, and one or more of an alkaline-earth-metal or an alkaline-earth-metal hydride, and hydrogenating the mixture at an elevated temperature and pressure. In one embodiment the mixture includes aluminum.

In certain embodiments, a method of producing hydrogen storage materials capable of reversible hydrogenation includes forming a mixture of an alkali-metal hydride, an alkali-metal amide or an alkali-metal imide, aluminum, and one or more of a transition metal catalyst compound and an alkaline-earth-metal or alkaline-earth-metal hydride. The mixture is then hydrogenated to provide a hydrogen storage material.

In other certain embodiments, a method of producing materials hydrogen storage materials of reversible hydrogenation includes: forming a mixture of LiH, aluminum metal, LiNH₂, Mg metal, and TiF₃ in a ball mill for at least 30 minutes, and then hydrogenating the mixture at an elevated temperature and pressure.

In yet other certain embodiments, a method for producing materials capable of reversible hydrogenation includes forming a mixture with molar ratios of aluminum to LiH of approximately 1:1. In another embodiment, the molar ratio of LiNH₂ to LiH is approximately 2:1. In yet another embodiment, the molar ratio of Mg to LiH is approximately 1:1. In one embodiment, the molar ratio of TiF₃ to LiH is approximately 0.05:1.

In certain embodiments, a method for producing materials capable of reversible hydrogenation includes hydrogenating the mixture at a temperature of above about 200° C., and wherein the hydrogen pressure is maintained above an equilibrium plateau pressure for hydrogen at the initial temperature.

In other certain embodiments, a method for producing materials capable of reversible hydrogenation includes hydrogenating the mixture at a temperature of above about 200° C. and at hydrogen pressures of about 125 atmospheres.

In yet other certain embodiments, a method is provided for delivering hydrogen. The method includes storing an amide and a complex hydride separately in one or more interconnected vessels, decomposing the amide, and reacting gases from the decomposing amide with the complex hydride to release hydrogen. In one embodiment, the complex hydride includes an alanate which may be, for example and without limitation, a lithium alanate or a sodium alanate. In another embodiment, the amide is one or more of a lithium amide or a sodium amide. In yet another embodiment, the gases include ammonia.

These features together with the various ancillary provisions and features which will become apparent to those skilled in the art from the following detailed description, are attained by the methods of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a graph showing a measurement of hydrogen concentration as a function of time during the first desorption of hydrogen from a mixture;

FIG. 2 is a graph showing a measurement of hydrogen concentration as a function of time during the first absorption of hydrogen from a mixture;

FIG. 3 is a graph showing a measurement of hydrogen concentration as a function of time during the second desorption of hydrogen from a mixture;

FIG. 4 is a graph showing a measurement of hydrogen concentration as a function of time during the third desorption of hydrogen from a mixture;

FIG. 5 as a linear plot of the hydrogen pressure surrounding the material as a function of time;

FIGS. 6 and 7 are a linear plot and log plot, respectively, of the pressure of hydrogen surrounding the material as a function of the hydrogen weight percent in the mixture; and

FIG. 8 is a van't Hoff Plot from PCT isotherm measurements at 250 C, 200 C, and 180 C.

### DETAILED DESCRIPTION OF THE INVENTION

Described herein are novel methods for synthesizing reversible hydrogen storage materials from a mixture including an alkali-metal hydride and an alkali-metal amide. The mixture further includes one or more of aluminum, an alkaline-earth-metal element, or any combination thereof. The mixture may alternatively include a catalyst. The present invention also avoids the problem of solvent contamination, associated with many of the prior art methods for fabricating mixtures of hydrogen storage materials having high hydrogen storage densities using a simple two-step dry synthesis preparation process from mixtures of alkali metal amides or imides and hydrides.

### General Method

In general, the method for producing a reversible hydrogen storage material includes mixing a) an alkali-metal hydride, b) one or more of an alkali-metal amide or an alkali-metal imide, and c) one or more of aluminum, an alkaline-earth-metal, an alkaline-earth-metal halide, or a hydride thereof. The mixture is hydrogenated at high pressure and at an elevated temperature to provide a hydrogen storage material. In an alternative embodiment, the mixture includes a transition metal catalyst compound.

### EXAMPLE

By way of example, one hydrogen storage material was produced from the following mixture, obtained as powders having 99% purity or better from Sigma-Aldrich Corp (St. Louis, Mo.): 0.185 grams of lithium hydride (LiH); 0.537 grams of magnesium (Mg) metal; 0.592 grams of aluminum (Al) metal; 1.033 grams of lithium amide (LiNH₂); and 0.12 grams of titanium trifluoride (TiF₃). On a molar basis, the ratio LiH:Mg:Al:LiNH₂:TiF₃ was 1.06:1.01:1.00:2.05:0.05, giving an elemental ratio Mg:Al:N:Li of 1.01:1.00:2.05:3.11.

Approximately 2 grams of the mixture was weighed in an argon glove box, where the concentration of oxygen and water were less than 10 ppm, and then loaded under argon into a stainless steel milling pot with a vial length of 2¼ inches and a diameter of 3 inches, and having a vial body and cap liner made of hardened 440C stainless steel. Two ½ inch and four ¼ inch stainless steel balls were placed in with the mixture, and the milling pot was sealed under argon using the provided screw-on cap with o-ring to permit airless dry grinding/mixing.

The sample was then processed as follows. The mixture was first ball milled for 30 min under argon gas in a sealed steel Spex mill milling pot (SPEX SamplePrep LLC, Metuchen, N.J.). Next, a 1.16 gram sample of the ball-milled mixture was removed from the milling pot in an Argon glove box and placed into a long stainless steel sample vial with a fritted stainless steel filter cap (Hy-Energy product SHV-2002, Hy-Energy LLC, Fremont, Calif.) and then sealed into a copper clad stainless steel sample holder (Hy-Energy product HSH-2001, Hy-Energy LLC, Fremont, Calif.) under argon. The sample holder was attached to a PCTPro-2000 instrument (Hy-Energy LLC, Fremont, Calif.) whose lines were purged of air using helium and vacuum.

As a last step, the ball milled mixture was then maintained at a temperature of 250 C and contacted with hydrogen gas (UHP grade, Airgas, Inc., Radnor, Pa.) repeatedly at various pressures. Specifically, the ball milled mixture was contacted with hydrogen to permit the mixture to absorb and then desorb hydrogen. The following procedure was repeated three times. First, the material was permitted to absorb hydrogen by pressurizing the material using a calibrated volume of approximately 12 ml at a high pressure of hydrogen (at a pressure of approximately 125 bar). Next, the mixture was permitted to desorb hydrogen by de-pressurizing the material using a calibrated volume of approximately 1.2 liter at a low pressure of hydrogen (at a pressure of less than 1 bar). The absorption measurements were conducted from 7 to 15 hours, or until there was little change in the rate of hydrogen absorption. The desorption measurements were conducted for from approximately 3.5 to approximately 23.5 hours, or until there was little change in the rate of hydrogen desorption.

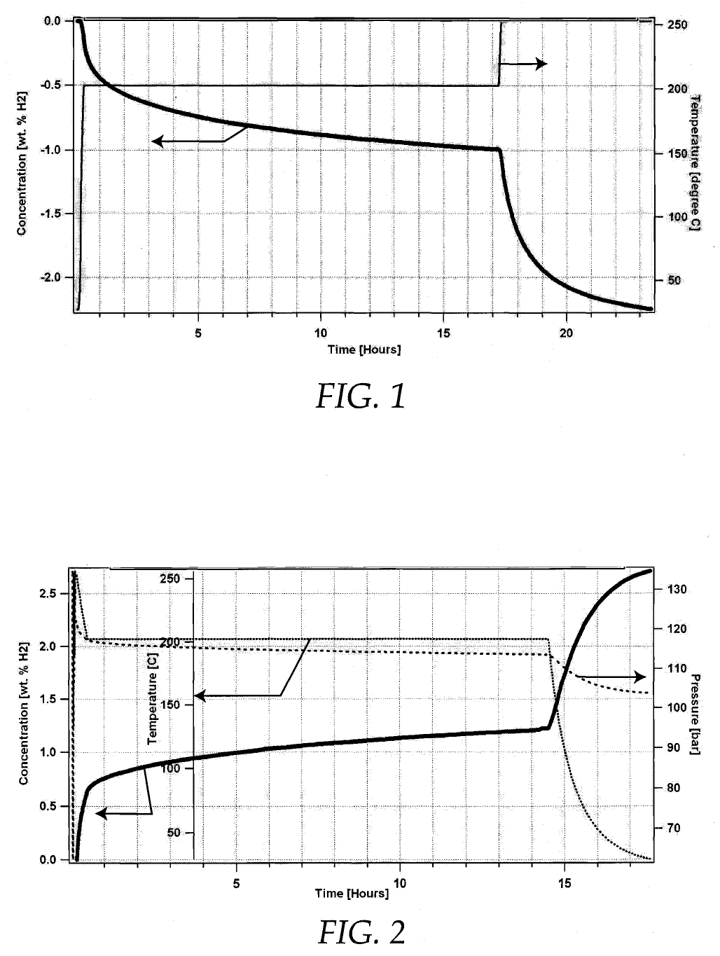

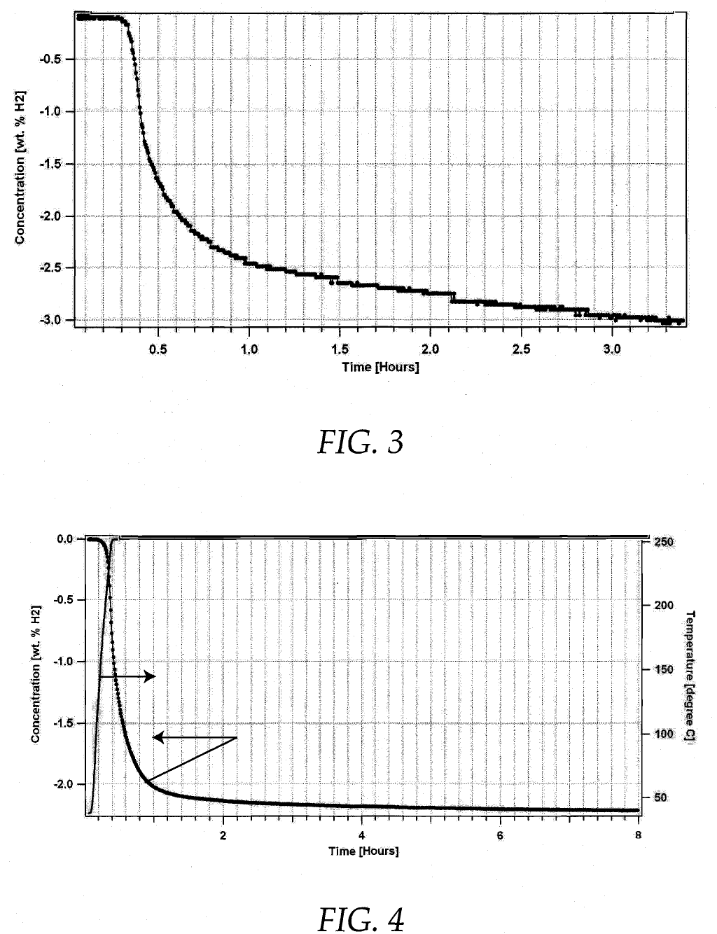

FIGS. 1, 2, 3, and 4 are graphs showing measurements of hydrogen concentration in the mixture as measured as a function of time during the first several absorptions and desorptions of hydrogen, that is during the exposure of the mixture to hydrogen at high pressure and at low pressure, respectively. More specifically, the measurement of FIG. 1 was taken during the first desorption of hydrogen, the measurement of FIG. 2 was taken by the subsequent first absorption of hydrogen, where the measurement of FIG. 3 was taken during the second desorption of hydrogen, and the measurement of FIG. 4 was taken during the third desorption of hydrogen from the mixture. FIGS. 1, 2, and 4 also show the mixture temperature, which was controlled during each measurement. Measurements of the hydrogen concentration shown in FIGS. 1-4 as a weight percent of the mixture was obtained using the Sieverts method of desorbing hydrogen is described, in part, in U.S. patent application Ser. No. 10/440,069, filed May 17, 2003, GROSS, “METHOD AND APPARATUS FOR MEASURING GAS SORPTION AND DESORPTION PROPERTIES OF MATERIALS,” the contents of which are incorporated herein by reference.

FIGS. 1, 3, and 4 show the desorption of hydrogen which was absorbed during the previous exposure of the mixture to high pressure hydrogen (as in, for example, FIG. 2). The hydrogenated mixture has thus been shown to be a reversible hydrogen storage material. The material has been formed directly from dry reagents, and is thus clearly advantageous over wet chemistry bases synthesis techniques. Further, no other gaseous or liquid intermediaries, such as ammonia are involved.

The thermodynamics of the hydrogenated mixture was demonstrated by performing an equilibrium Pressure Concentration Temperature (PCT) measurement of the material in contact with hydrogen gas. The measurement included a PCT isotherm to quantify the amount of hydrogen that can be stored in the material and the pressure at which hydrogen is released at a given temperature. The PCT isotherm was obtained using the Sieverts method of desorbing hydrogen from the processed mixture in a known volume (13.122 ml) to a reservoir volume of 5.24 ml in multiple steps.

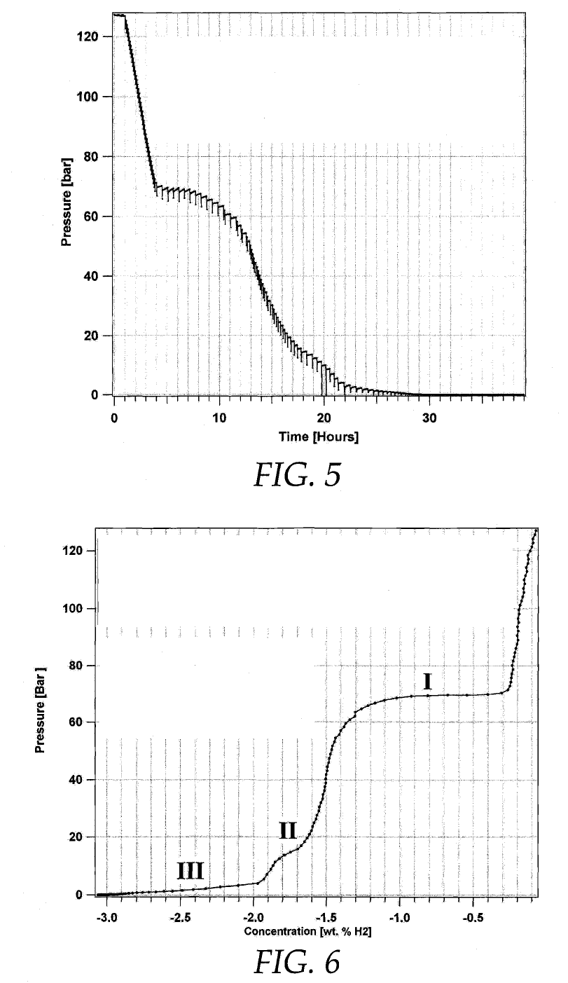

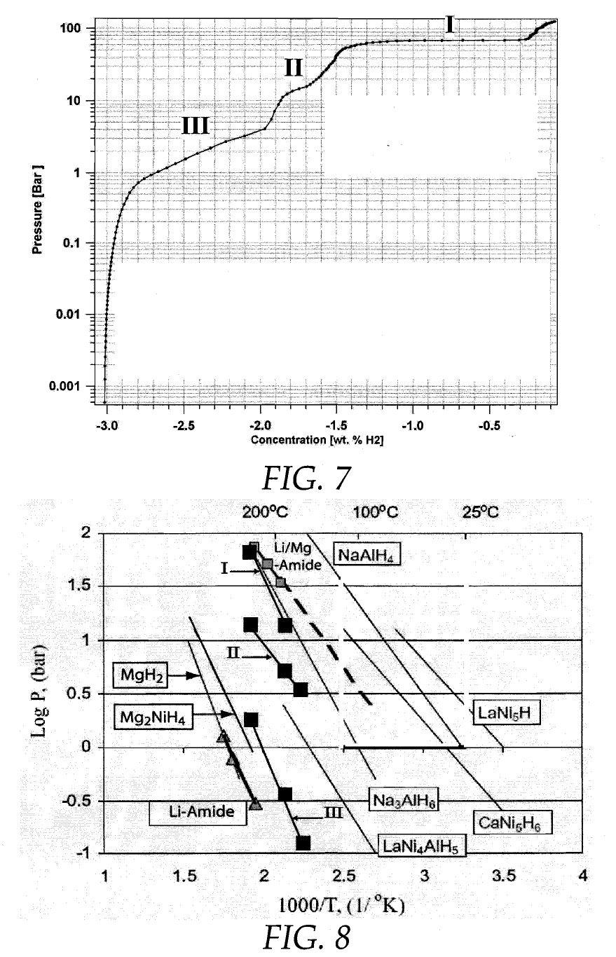

FIG. 5 shows a linear plot of the hydrogen pressure surrounding the hydrogen storage material formed in the above Example as a function of time as small doses of gas are removed from the volume containing the material. This data is used to create the PCT isotherms of the processed mixture that are shown in FIGS. 6 and 7 as linear plot and log plot, respectively. These show the pressure of hydrogen surrounding the material at the end of each dose as a function of the hydrogen weight percent in the mixture. The temperature of the processed mixture was maintained at 250 C during these measurements. In each step the reservoir pressure was reduced to 4 bar lower than the final pressure measured on the sample in the previous step.

The relatively flattened portions of the curves of FIGS. 5, 6, and 7 (the “plateaus”) are indicative of a phase change, as occurs, for example, during desorption of chemically bound hydrogen, as in a hydride. More specifically, the figures indicate the desorption of at least 3 different phases at 250 C. These near equilibrium desorption phase transitions are labeled I, II, and III. As is known from the thermodynamics of phase transitions, these transitions may involve the chemical interaction or release of gas from more than a single compound or phase in the sample. The length of each plateau indicates the content of gas released (and consequently, stored) by each of the three reactions in the sample. Each separate plateau reaction may independently store more hydrogen on a weight basis, than its contribution to the total stored weight percent hydrogen of this mixture.

The plateau pressures in FIGS. 6 and 7 decrease from I to III indicating more strongly bonded hydrogen in reaction III versus I. Because the energy of hydrogen release follows the Gibbs free energy rule (ln(Peq)=−ΔH/RT+ΔS/R where Peq is the equilibrium pressure, ΔH is the enthalpy of desorption, ΔS is the entropy of desorption, R is the universal gas constant and T is the temperature) the equilibrium pressure of hydrogen release at other temperatures can be estimated. From a practical perspective the highest plateau (I) is the most advantageous because it should produce a useful pressure at lower operating pressures (approximately 1 bar at 120 C).

PCT isotherm measurements on the hydrogen storage material of the Example were also performed at 200 C and 180 C. FIG. 8 is a van't Hoff Plot from PCT isotherm measurements at 250 C, 200 C, and 180 C, along with the known decomposition reactions of several other compounds. The plateau pressures for the three desorption reactions of the mixture are shown as log (Peq) versus 1/T in the van't Hoff Plot of FIG. 8. These measurements indicate that the three reactions, corresponding to an labeled as I, II, and III, do not correspond to the known decomposition reactions, lie between Mg₂NiH₄ and Na₃AlH₆ in thermodynamic stability. Thus, this is a hydrogen storage material not represented on FIG. 8 and having a capacity of 3 wt. % hydrogen that is close to that of Mg₂NiH₄ (3.6 wt %) and much less stable.

As is generally known, the temperature and pressure at which hydrogen storage materials operate depend on their chemical composition. The PCT measurements described above may be performed to determine the operating temperature and pressure ranges of any hydrogen storage material, including hydrogenated mixtures of the present invention. Thus, for example, the effect of the molar ratios of LiH, Mg, Al, LiNH₂, and TiF₃ of the above mixture, or any of the constituent parts of the following mixtures, may be varied to determine optimal hydrogen storage characteristics.

### Discussion

While the above example stands on its own as a method of synthesizing a reversible hydrogen storage material, the following discussion, which are not meant to limit the scope of the present invention, provides a plausible theory of the hydrogen storage material and, by analogy, to other mixtures which may be hydrogenated to form a hydrogen storage material.

One explanation for the measurements obtained on the hydrogen storage material of the Example is that the hydrogenated mixture forms an alanate, an amide, and a hydride/transition metal hydride. More specifically, the mixture in the Example (LiH:Mg:Al:LiNH₂:TiF₃ equal to 1.06:1.01:1.00:2.05:0.05) was thus chosen to have an elemental balance for the direct synthesis of the following mixture:

LiAlH₄+2LiNH₂+MgH₂+0.05TiF₃, Mixture (5)

that is, the mole fraction of magnesium:aluminum:nitrogen:lithum in the mixture of the above example was intended to be 1:1:2:3, and has an actual mole fraction ratio of 1.01:1.00:2.05:3.11.

In analogy to the direct synthesis of sodium alanates from the hydrogenation of sodium hydride and aluminum powers as described in U.S. Pat. No. 6,793,909, the contents of which are hereby incorporated by reference, the hydrogenation of LiH and Al may have combined in the above Example to form LiAlH₄ or another alanate, or aluminum-amide/imide alloy resulting a mixture similar to that of Mixture 5. It is proposed, though by no means limiting to the scope of the present invention, that the measurements on the hydrogen storage material of the Example reflect the following reaction:

LiAlH₄+2LiNH₂+MgH₂+0.05TiF₃ [symbol] x(Li—Mg—Al—N—H)+y(M-H)+z(M-N—H)+wH₂.

Such mixtures may have advantages over mixtures without amide or imide compounds, such as the capability of reversibly storing more hydrogen than the alanate by itself, or the uptake and release of hydrogen at more practical temperatures and pressures than equivalent alanates, or be much more cost-effective to prepare as a hydrogen-storage media. Further, it is proposed that, based on analogy to other hydride systems, that the range of stoichiometries yielding hydrogen storage materials may be, for example:

alanate+(0.2-3.0)amide+(0.2-3.0)hydride/metal+(0.001-0.5)catalyst precursor. Mixture (6)

By way of one explanation, which is not meat to limit the scope of the present invention, Reactions 1 and 2 may be combined to give an overall reaction of:

LiAlH₄+LiAl(NH₂)₄ [symbol] 2LiAl(NH)₂+4H₂ 5.9 wt. % H₂, Reaction (7)

and thus a mixture of LiAlH₄ and LiAl(NH₂)₄ (an alanate and an amide) may react to form LiAl(NH)₂ (an imide) and H₂. While Reaction 7 does not have as high of a hydrogen storage capability as Reaction 1 (5.9 wt. % H₂ vs. 7.5 wt. % H₂), Reaction 7 does have the advantage of not requiring ammonia as a reactant. By comparison the method described herein uses a simple amide and pure metals and LiH as starting materials. It is possible that one of the hydrogen release reactions I, II or III in our materials is or is analogous to Reaction (7) above, and thus that an imide could be substituted or added to the starting mixture for direct synthesis of a hydrogen storage material.

Another Li—Al hydride/amide/imide reaction that is similar to Reaction 3 is:

Li₃AlH₆+2LiAl(NH₂)₄ [symbol] 2LiNH₂+3LiAl(NH)₂+6H₂ 4.8 wt. % H₂. Reaction (8)

Alternatively, the addition of an appropriate catalyst, including but not limited to transition metal catalyst compounds, including but not limited to TiF₃ or TiCl₃, are capable of producing a reversible gaseous hydrogen delivery system with a high gravimetric energy density. Again, the disadvantage of this system is that these two compounds are difficult or impossible to form directly from the element and are generally synthesized using wet chemistry techniques or reaction with salts which are energetically unfavorable, costly and may contaminate the end products with solvents. By comparison the method described herein uses a simple amide and pure metals and LiH as starting materials. It is possible that one of the hydrogen release reactions I, II or III in our materials is or is analogous to Reaction (8) above.

In addition to systems based on Reactions (7) or (8), which could contain the material in one container, it is also possible to provide LiAl(NH₂)₄ separate from LiAlH₄ (or Li₃AlH₆), in one or more containers. The decomposition of LiAl(NH₂)₄ produces ammonia, which would then be provided to react with the alanate, as in Reaction (1). This configuration may be particularly useful at thermodynamic conditions that are not favorable for the combined Reaction (7) or (8).

Another proposed hydrogen storage material include the substitution of boron for aluminum in Reactions 1-8, such as:

LiBH₄+LiB(NH₂)₄ [symbol] 2LiB(NH)₂+4H₂ 7.7 wt. % H₂, or

Li₃BH₆+2LiB(NH₂)₄ [symbol] 2LiNH₂+3LiB(NH)₂+6H₂ 6.3 wt. % H₂.

and thus the hydrogenation of a mixture where boron is substituted for aluminum in the Example is expected to yield a hydrogen storage material.

Yet another hydrogen storage material includes an alkali-metal-alanate (including, but not limit to, LiAlH₄ or Li₃AlH₆) and an alkali-metal amide or imide (including, but not limited to, LiNH₂ or Li₂NH). The alanate/amide or alanate/imide mixture reacts to form an alkali-metal-alanate-amide compound (e.g., Li—Al—N—H) and reversibly release hydrogen.

In addition, an alkaline-earth-metal element (including, but not limited to Mg) or alkaline-earth-metal halide (including, but not limited to, MgCl) may react with one of the other precursors to form a hydride that destabilizes the alkali-metal hydrides/alkali-metal amides storage materials by reacting with the storage materials or by substituting into one of the storage materials to alter the thermodynamics of hydrogen uptake and release, and thus may advantageously alter the chemistry of the mixture. Thus while the alkaline-earth metal in the mixture of the Example is believed to produce a better hydrogen storage material, the alkaline-earth is not believed to be necessary for the direct synthesis of a hydrogen storage material.

In another alternative hydrogen storage material, a third transition metal-halide including but not limited to titanium halides (such as TiF₃ TiCl₃) is added to alkali-metal hydrides and alkali-metal amides. The transition metal may react with the alkali-metal hydrides alkali-metal amides materials to form metallic Ti or a Ti-transition metal alloy that may act as a catalyst to speed up the uptake and release of hydrogen. The transition metal may be added in many different forms, for example TM-halides, TM-oxides, TM-nanoparticles, TM-nanoclusters stabilized by an organic compound.

The materials described herein have the potential to operate at much lower pressures than lithium-alanates, reducing the parasitic energy loss and safety penalties associated with high-pressure high-temperature storage.

In conclusion, the methods described herein are believed to form hydrogen storage materials by hydrogenating one or more of the following mixtures: hydrides and amides of alkali metals (Li, Na, and K); hydrides and amides of alkali metals and simple hydrides of alkaline-earth elements (for example Mg, Ca, and Ba); hydrides and amides of alkali metals and aluminum; hydrides and amides of alkali metals, aluminum, and simple hydrides of alkaline-earth elements.

In addition, the synthesis methods described herein are believed to be applicable to mixtures of the previous paragraph having the following substitutions: replacing some or all of the amide with an imide; replacing some or all of the aluminum with boron or a transition metal such as, for example, Co, Fe, Mn, Ni, Ti, V, and Zr; and replacing some or all of the alkali metal hydride with an alkali metal. The invention, therefore, should not be construed as limited solely to the production of hydrogen storage materials from the LiNH₂, LiH, Mg, Al, and TiF₃ specifically, as in the following Example.

Preferred embodiments of the alkali metal for one or more of the alkali-metal hydride, alkali-metal amide, or alkali-metal imide include, but are not limited to, lithium (Li), sodium (Na), and potassium (K). Preferred embodiments for the alkali-metal hydride include, but are not limited to, one or more of lithium hydride (LiH), sodium hydride (NaH), and potassium hydride (KH). Preferred embodiments of an alkali-metal amide or imide include, but are not limited to, lithium amide (LiNH₂), lithium imide (Li₂NH), sodium amide (NaNH₂), sodium imide (Na₂NH), potassium amide (KNH₂), or potassium imide (K₂NH). Preferred embodiments of a transition metal catalyst compound include, but are not limited to, TiCl₃ and TiF₃. Preferred embodiments of the alkali-earth metal include, but are not limited to magnesium (Mg) and calcium (Ca). Preferred embodiments halogen of the alkali-earth-metal halide include, but are not limited to beryllium (Be), magnesium (Mg), or calcium (Ca), which may also be combined with fluorine (F), chlorine (Cl) or bromine (Br).

Preferred embodiments for the mixture include, but are not limited to, one or more of the following molar ratios: alkali-metal amide to alkali-metal hydride ratios of 0.2:1 to 20:1, 1:1 to 4:1, or approximately 2:1. Other certain embodiments include the following molar ratios: aluminum to alkali-metal hydride of from 0.1:1 to 10:1, from 0.5:1 to 5:1, or approximately 1:1; transition metal catalyst compound to alkali-metal hydride ratio of less than 0.1:1 or less than approximately 0.05:1; and alkaline-earth-metal, in elemental or hydride form, to alkali-metal hydride ratio of 0.1:1 to 10:1, from 0.5:1 to 5:1, or approximately 1:1.

Preferred embodiments for hydrogenating the mixture include, but are not limited to: maintaining a pressure greater than 10 bar, greater than 50 bar, greater than 100 bar, or greater than approximately 150 bar; and maintaining a temperature greater than 25 C, greater than 50, greater than 100, greater than 150, greater than 150 C, greater than 200 C, or greater than 250 C. Alternatively, lower pressures and/or temperatures may be used, with a commensurate increase in the hydrogenation and dehydrogenation times.

Reference throughout this specification to “certain embodiments,” “one embodiment” or “an embodiment” means that a particular feature, structure or characteristic described in connection with the embodiment is included in at least one embodiment. Thus, appearances of the phrases “in certain embodiments,” “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments, various features of the inventions are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim which may be made on this invention require more features than are expressly recited in that claim. Rather, inventive aspects lie in a combination of fewer than all features of any single foregoing disclosed embodiment.

I claim:

1. A method for producing compounds capable of reversible hydrogenation, comprising:
forming a mixture including
an alkali-metal hydride,
one or more of an alkali-metal amide or an alkali-metal imide, and
a material selected from the group consisting of aluminum, one or more of an alkaline-earth-metal or an alkaline-earth-metal hydride, and any combination thereof, and
hydrogenating said mixture at an elevated temperature and elevated hydrogen pressure.

2. The method of claim 1, where said mixture includes a transition metal catalyst.

3. The method of claim 2, where said transition metal catalyst includes a titanium halide.

4. The method of claim 1, where said group includes one or more of an alkaline-earth-metal or an alkaline-earth-metal hydride, and where said one or more of an alkaline-earth-metal or an alkaline-earth-metal hydride includes magnesium.

5. The method of claim 1, where said alkali-metal hydride includes LiH.

6. The method of claim 5, where said group includes aluminum, and where the molar ratio of said aluminum to said LiH is approximately 1:1.

7. The method of claim 1, where said alkali-metal of said alkali-metal hydride, said alkali-metal amide or said alkali-metal imide includes one or more of lithium, sodium, or potassium.

8. The method of claim 1, where said one or more of an alkali-metal amide or an alkali-metal imide includes one or more of lithium amide, sodium amide, or potassium amide.

9. The method of claim 5, where said one or more of an alkali-metal amide or an alkali-metal imide includes LiNH₂.

10. The method of claim 9, where the molar ratio of said LiNH₂ to said LiH is approximately 2:1.

11. The method of claim 4, where said alkali-metal hydride includes LiH, and where the molar ratio of said Mg to said LiH is approximately 1:1.

12. The method of claim 3, where said titanium halide is TiF₃, where said alkali-metal hydride includes LiH, and where the molar ratio of said TiF₃ to the LiH is approximately 0.05:1.

13. The method of claim 1, where said group includes aluminum and one or more of an alkaline-earth-metal or an alkaline-earth-metal hydride.

14. The method of claim 1, wherein said step of forming is carried out in an atmosphere consisting essentially of argon.

15. The method of claim 1, wherein said elevated temperature is greater than approximately 200 C.

16. The method of claim 1, wherein said elevated pressure is approximately 125 bar.

17. The method of claim 1, where said mixing includes mixing in a ball mill.

18. A method delivering hydrogen comprising:
storing an amide and a complex hydride separately in one or more interconnected vessels;
decomposing said amide; and
reacting gases from said decomposing amide with said complex hydride to release hydrogen.

19. The method of claim 18, where said complex hydride includes an alanate.

20. The method of claim 19, where said alanate is one or more of a lithium alanate or a sodium alanate.

21. The method of claim 18, where said amide is one or more of a lithium amide or a sodium amide.

22. The method of claim 18, where said gases include ammonia.
